(19) United States
(12) Patent Application Publication
(10) Pub. No.: US 2007/0006920 A1
(43) Pub. Date: Jan. 11, 2007

(54) Combined storage facility for co2 and natural gas

(75) Inventors: Knut Børseth, Tarnasen (NO); Henrik Fleischer, Slependen (NO)

Correspondence Address: BIRCH STEWART KOLASCH & BIRCH, PO BOX 747, FALLS CHURCH, VA, 22040-0747, US

(73) Assignee: Sargas AS, Oslo (NO)

(21) Appl. No.: 10/583,274

(22) PCT Filed: Dec. 16, 2004
(86) PCT No.: PCT/NO04/00390

§ 371 Date: Sep. 1, 2006

(30) Foreign Application Priority Data
Dec. 16, 2003 (NO) 20035622

(51) Int. Cl. B67D 5/54

(52) U.S. Cl. 137/209; 137/575

(57) ABSTRACT

A method and an installation for alternating storage of CO₂ and natural gas in a way that ensures minimal mixture of the gases, is described. CO₂ and natural gas are alternately stored in a tank installation comprising a plurality of tanks connected in series, where CO₂ is always filled and emptied through a first tank in the series of tanks, and where natural gas always is filled and emptied through a last tank in the series of tanks.

### FIELD OF THE INVENTION

The present invention relates to a method and a device for temporary storage of fluids, such as during transport of the fluids. In more detail, the invention relates to a method and a device for carrying out the method for alternating storage of two or more fluids in the same tanks, but where mixing of the fluids is avoided to the greatest extent possible. In particular, the present invention relates to a method and also a device for alternating storage, such as during transport, of natural gas and CO₂, and also a vessel comprising the device for storage.

### BACKGROUND

Technology for separation of CO₂ from the flue gas from thermal power plants is being developed, where the separated CO₂ is deposited, for example, by injection into an oil field or a gas field. It is often not possible or it is impracticable and costly to place a thermal power plant where fuel gas is available as fuel for the thermal power plant and at the same time there is a possibility for depositing CO₂ nearby.

CO₂ can be deposited in wells that are no longer in use, in aquifers which abandoned wells go through, or as a pressure support in producing wells. There may also be formations isolated from producing gas fields or oilfields near gas fields or oilfields that are suitable for safe deposition of CO₂.

In instances where thermal power plants can not be built in direct connection to a gas field or an oilfield, gas as fuel for a thermal power plant must be transported from the field and to the thermal power plant, while CO₂ which is separated from the flue gas must be transported to the deposition location.

Gas, such as natural gas as fuel for the thermal power plant, and also CO₂ can be transported in pipelines, one for transport of the natural gas and one for return of CO₂. However, it is costly to lay dedicated pipes to and from a thermal power plant. The flow to and from the field in such pipelines is small and for a power plant of 100 MW can constitute as little as 2 to 10% of the gas that is produced in a field. Such small pipelines over longer distances will often be unprofitable.

Pipelines from a field to a customer are normally pipes that transport gas and/or oil from production location to the customer. If, in addition to the pipe for transport of gas and/or oil, a pipe for return of CO₂ is to be laid, the costs will be unacceptably high. Furthermore, planning, the decision process and the actual laying of such pipes take a long time.

An alternative can then be to transport fuel gas to a thermal power plant and return CO₂ across ocean areas or along the coast in ships with separate tanks for CO₂ and natural gas in pressurised and/or liquid form. The pressure in such tanks can be 200 to 300 barg, while it is required that gas is delivered to the thermal power plant at 20-40 barg. Corresponding pressures are also relevant for transport of CO₂ and delivery of the same, respectively, for deposition at an oilfield/gas field. In other words, 10-15% of the gas will remain in the tanks after delivery of natural gas and CO₂, respectively, to a gas driven power plant and deposition, respetively. If one should use the same tank for both gases, this will result in an unacceptable mixing of the gases. Firstly, an unacceptably large part of the costly natural gas would be returned to the field for deposition together with CO₂ and secondly, an unacceptable amount of CO₂ would be delivered together with the natural gas at the same time.

Thus, transport in tanks onboard ships will require that the gases/fluids are transported in separate tanks/containers, a solution which will be unacceptably costly and space demanding as the tanks for CO₂ will stand empty during transport of natural gas and vice versa, so that a large part of the total transport capacity of the vessel will be unused at any time.

U.S. Pat. No. 5,203,828 describes use of a membrane in a tank for storage of different fluids, such as crude oil and water, where one fluid is stored on the one side of the membrane and the other on the other side of the membrane to avoid that the one fluid is contaminated by the other. However, this is a construction which will be subjected to wear and which is complicated to maintain.

### SUMMARY OF THE INVENTION

An aim of the present invention is to provide a solution for temporary and alternating storage of different fluids and, in particular, for transport of natural gas and CO₂ where the above mentioned disadvantages are overcome. This aim, and other aims, which a person skilled in the arts will understand by reading the enclosed description, are obtained by applying tanks connected in series as described below.

According to a first aspect, the present invention relates to a method for alternating storage of natural gas and CO₂ in a tank installation, where the gases are stored in a plurality of tanks which are connected in series, where natural gas is supplied to and taken out of, respectively, a tank at one end of the tanks which are connected in series and where CO₂ is supplied to and taken out of, respectively, a tank at the opposite end of the tanks that are connected in series.

According to one embodiment, the natural gas and CO₂ have a pressure and temperature that lie above the cricondenbar of the actual gas. It is preferred that pressure and temperature are kept above the cricondenbar of the actual gas or gas mixture to avoid condensation of gas with the resulting problems of multiphase flow and collection of liquids in tanks and pipes. To ensure that the pressure in the tanks is above the cricondenbar of the gas, it is preferred that natural gas is stored at a pressure of from 120 to 300 barg, and CO₂ is stored at a pressure of from 80 to 150 barg.

According to one embodiment, the tank installation is arranged onboard a vessel, where natural gas is supplied to the tank installation and where CO₂ is removed from the tank installation when the vessel lies connected to a gas field, and is emptied of natural gas and supplied with CO₂ when the vessel lies at a facility for use of the natural gas.

According to a second aspect, the present invention relates to a combined installation for alternating storage of natural gas and CO₂, where the installation comprises a plurality of tanks that are connected in series with the help of connecting pipes and where a CO₂ line is arranged for supply of CO₂ to and removal of CO₂ from, respectively, the tank installation which is connected to a first tank in the series of tanks, and a natural gas line for removal of natural gas and supply of natural gas, respectively, to a last tank in the series of tanks.

According to one embodiment, the CO₂ line has an outlet near the bottom of the first tank and that the natural gas line has an outlet near the top of the last tank. CO₂ is heavier than natural gas. As CO₂ is filled from the bottom of the first tank, the least possible mixing of the gases will be ensured in this tank, as CO₂ will lie predominately at the bottom and rise upwards as the tank is filled, while the natural gas will lie uppermost in the tank and be pushed up and out of the tank.

According to a second embodiment, the connecting pipes have a first opening near the top of the tank that streamwise lies nearest the first tank and a second opening near the bottom of the next tank in the series of tanks. CO₂ or gas mixtures with a high concentration of CO₂ will be heavier than natural gas. It is therefore appropriate, from the same consideration as in the paragraph above, always to fill the heaviest gas from the bottom of any tank in the series.

It is appropriate that the installation encompasses from 5 to 200 tanks in series.

According to a special embodiment, the installation encompasses from 20 to 50 tanks in series.

According to a third aspect, the present invention relates to a vessel for alternating transport of natural gas and CO₂, where the vessel comprises a tank installation encompassing a plurality of tanks which are connected together in series with the help of connecting pipes and where a CO₂ line is arranged for supply of CO₂ to and removal of CO₂ from, respectively, the tank installation which is connected to a first tank in the series of tanks, and a natural gas line for removal of natural gas and supply of natural gas, respectively, to a last tank in the series of tanks.

### SHORT DESCRIPTION OF THE FIGURES

FIG. 1 shows a principle diagram of a tank installation according to the present invention at unloading of natural gas and loading of CO₂;

FIG. 2 shows a principle diagram of an installation with tanks according to the present invention at unloading of CO₂ and loading of natural gas;

FIG. 3 shows a longitudinal section through a first preferred tank;

FIG. 4 shows a longitudinal section through a second preferred tank;

FIG. 5a shows a longitudinal section through a third preferred tank;

FIG. 5b shows a transverse section of the tank according to FIG. 5a;

FIG. 6 shows the composition of the gas that leaves a tank with simultaneous loading of CO₂ and unloading of natural gas;

FIG. 7 shows the composition of the gas that leaves an installation with two tanks at loading of CO₂ and unloading of natural gas;

FIG. 8 shows the composition of the gas that leaves an installation with ten tanks at loading of CO₂ and unloading of natural gas;

FIG. 9 shows the composition of the gas that leaves an installation with one hundred tanks at loading of CO₂ and unloading of natural gas:

FIG. 10 shows schematically a ship with the present tank installation connected to a loading buoy at a gas field, and

FIG. 11 shows a land-based installation for use with a combined storage facility according to the present invention.

### DETAILED DESCRIPTION OF THE INVENTION

The present invention relates to a combined storage facility for hydrocarbon gas, such as natural gas, and CO₂, where the storage facility is used, for one period of time, for storage of CO₂ and, for another period of time, is used for storage of natural gas. Such a combined storage facility is especially appropriate for transport, for example, onboard a vessel, where natural gas is brought from a gas field to a land-based installation and CO₂ for re-injection is transported from land to the gas field.

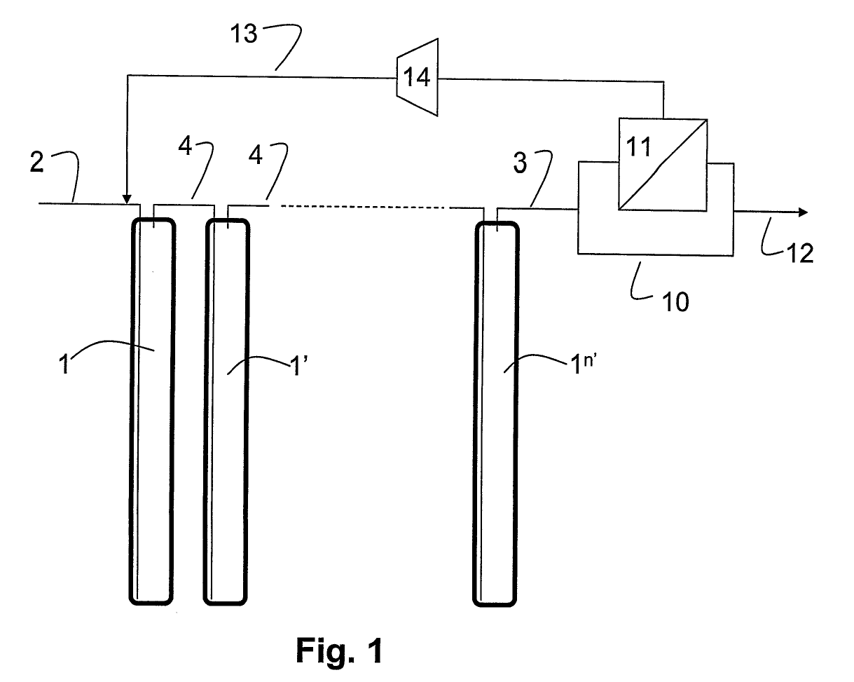

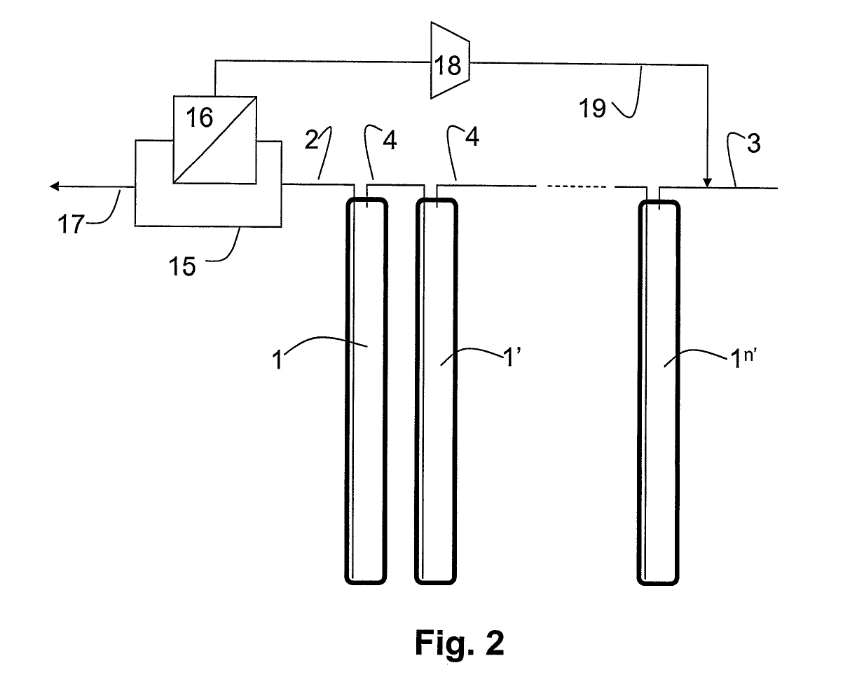

FIGS. 1 and 2 show schematically a combined storage facility, according to the present invention, for CO₂ and natural gas at removal and filling, respectively, of natural gas, simultaneously with filling and removal of CO₂, respectively. The combined storage facility comprises a plurality of tanks 1, 1′, . . . 1^{n′} which are connected to each other in series through connection pipes 4, 4′, . . . 4^{n′}. CO₂ is filled and removed, respectively, through a CO₂ pipe 2 that has its opening near the bottom of the first tank 1, while natural gas is filled and removed, respectively, through a natural gas pipe 3 which has its opening near the top of the last tank 1^{n′} of the tanks connected in series.

CO₂ gas has a greater density that natural gas, which is mainly comprised of methane. The connection pipes 4, 4′, etc. run therefore from the top of the tank that is nearest the supply of CO₂ to the bottom of the next tank. In this way, gas is taken out near the top of the tank that is nearest the CO₂ supply and is supplied near the bottom of the next tank at filling of CO₂. At the same time as CO₂ is being loaded in this way, natural gas is taken out through the natural gas pipe 3.

At filling of natural gas, the natural gas is supplied through the natural gas pipe which has its opening near the top of the last tank 1^{n′}. Then the gas flows from tank to tank via the connection pipes 4, opposite to the flow direction of the gas during loading of CO₂.

The present installation is thus emptied of natural gas at the same time as it is being filled with CO₂ and vice versa. By adapting the speed of emptying and filling, respectively, one can prevent undesirable vortex formation and mixing of gases in each tank. The fact that the connection pipes carry the gas stream from the top of one tank to the bottom of the next, or vice versa at reversed direction of flow, has the effect that the density of the gases helps to obtain an approximately plug flow through the present installation.

If it can be tolerated for the intended purpose, the natural gas which is taken out of the natural gas pipe 3 can be supplied directly to the intended purpose. If the intended purpose for the natural gas is use in a gas driven power plant, it can be appropriate to ensure that the gas taken out at the end, which contains some CO₂, is mixed with pure natural gas before use. Alternatively, the gas can be cleaned as described in FIG. 1, where natural gas and CO₂ are separated in a separation unit 11. This separation unit 11 can be any separation unit which is used conventionally to separate natural gas and CO₂, such as, for example, membrane based separation units or physical or chemical absorption/desorption units. However, a person skilled in the arts will understand that other types of units can also be used.

At the start of the unloading of natural gas, the gas in gas line 3 will be relatively clean with small amounts of CO₂, and separation is unnecessary. Therefore, the gas can be taken out via a circulation pipe 10 to a natural gas outlet 12. When the content of CO₂ in the stream taken out in gas line 3 rises above an predetermined level, which one does not wish to exceed, the circulation pipe 10 is closed and the gas from pipe 3 is led through a separation unit 11 for separation of natural gas and CO₂. CO₂ from the separation unit 11 is fed via a return pipe 13 and is pumped, with the help of a pump 14, back to the CO₂ pipe 2 and is led into the storage installation. Cleaned natural gas is then taken out through the natural gas outlet 12.

In FIG. 2, that shows emptying of the system for CO₂ and filling of natural gas, a corresponding separation unit 16 can be arranged. At the start of the unloading of CO₂, this gas stream is relatively clean, with little natural gas mixed in, and cleaning is therefore unnecessary. Therefore, the CO₂ steam is led via a circulation pipe 15 directly to a CO₂ outlet 17. As the mixing in of natural gas becomes more pronounced and the level of natural gas in the CO₂ rises above a predetermined concentration, the circulation pipe 15 is closed and the gas is led thereafter through separation unit 16. In the separation unit 16, the gas stream from the CO₂ pipe 2 is separated into a stream rich in natural gas and a stream rich in CO₂. The stream rich in natural gas is led to the natural gas pipe 3 and into the tank installation in a return pipe 19. The gas in line 19 is compressed to a desired pressure with the help of a pump 18. The stream rich in CO₂ is led to the CO₂ outlet 17 and from there further on to injection, deposition or other application.

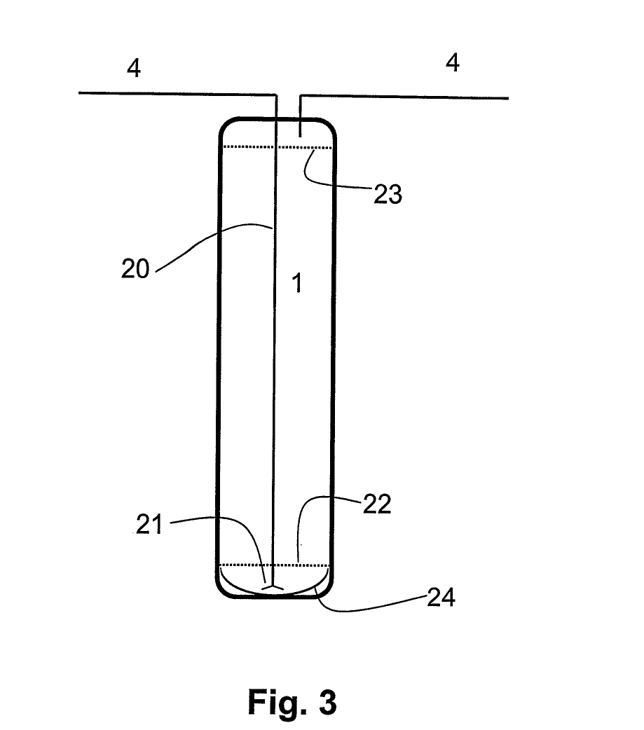

FIG. 3 shows an embodiment of a tank according to the present invention. A connection pipe 4 that comes from a neighbouring tank which lies in the direction of the CO₂ pipe in the system of tanks, goes into the top of tank 1 and runs down in a central pipe 20 in the tank. Near the bottom of the tank there is an expansion 21 in the pipe to reduce the flow velocity of the incoming gas. To reduce the flow, it is also preferred to arrange a rounding-off 24 in the bottom. A grid 22 over the bottom of the tank also reduces the flow in the tank. Near the top of the tank, which is extended and approximately cylindrical, a grid 23 is arranged to reduce the streaming at the inflow of gas through the connection pipe 4′ which is in the direction of the natural gas pipe 3. A first tank, i.e. the tank that is directly connected to the CO₂ pipe, will in principle be the same as that shown in FIG. 3. In this first tank, the connection pipe 4 is replaced by the CO₂ pipe 2 that runs down to the bottom of the tank 4 in the same way. A last tank in the installation, i.e. the tank that is connected to the natural gas pipe 3, will also, in principle, be identical to the tank shown in FIG. 3, with the exception here that the connection pipe 4′ is replaced by the natural gas pipe 3.

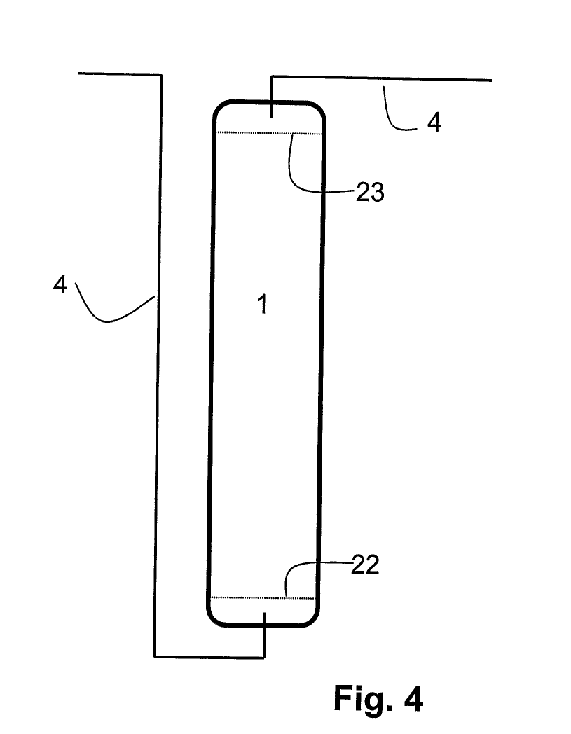

FIG. 4 shows an alternative tank, where the connection pipe 4 from the one side that is nearest the CO₂ pipe 2, runs outside the tank and runs in through the bottom of the tank. The connection pipe 4′ is arranged correspondingly to that shown with reference to FIG. 3. Adaptations are likewise made at the openings of the connection pipes to reduce the flow velocity and thus the mixing of gases in the tank, such as a widening of the flow area and the grids 22, 23. A first and a last tank in the installation will also be identical to the tank shown here with the same exceptions as indicated above.

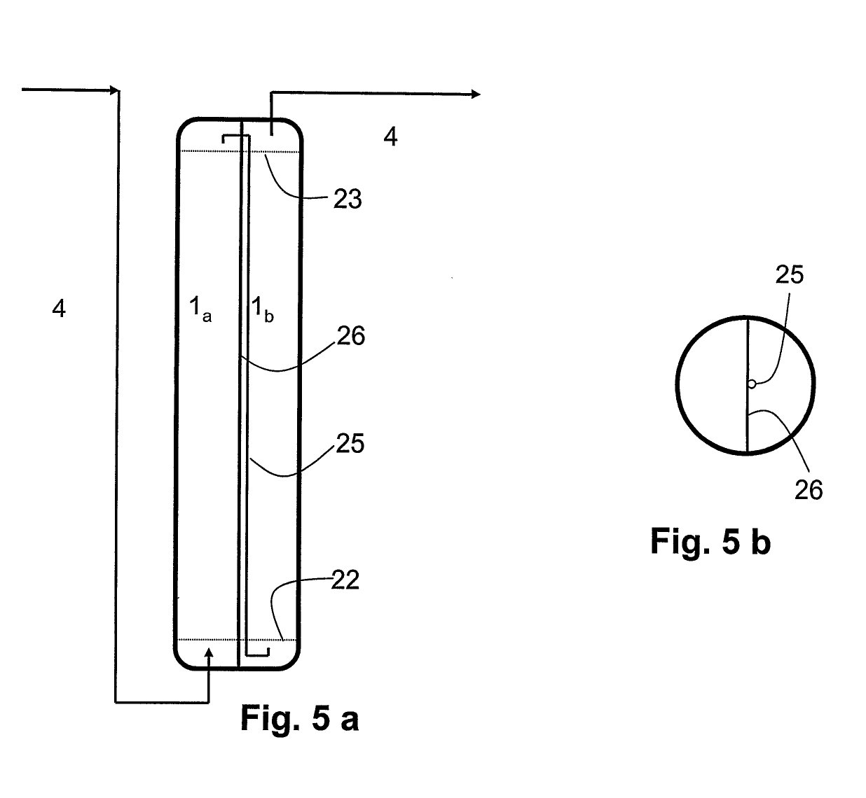

FIGS. 5a and 5b show a longitudinal section and a transverse section, respectively, of an alternative tank where the inside of the tank is divided in two by a partition that runs axially in the tank. CO₂ and natural gas, respectively, or a mixture of the two, are led into and out of the tank as shown in FIG. 4, but a transfer pipe 25 is arranged from the top of the one part of the tank to the bottom of the other part. In practice, one tank can in this way be divided into several tanks which in practice will function as a plurality of tanks connected in series.

It is important that the supply or the connection pipe 4 which comes in from the side that is nearest the CO₂ pipe, runs out into the bottom of the tank and that the supply or the connection pipe 4′ that lies nearest the natural gas pipe, runs out at the top of the tank in all the tanks. In this way one can use the fact that CO₂ has a greater density than natural gas and remains lying in the bottom of the tank and only to a small extent mixes with the natural gas which may be present in the tank. As the natural gas is always taken out from the top of the tank and CO₂ is always taken out from the bottom, one uses the effect which is provided by this density difference.

In this way one can obtain a better separation and less mixing of the gases than what seems theoretically possible from the above considerations. The stream can thus be very close to plug flow and the number of tanks where there actually will be a mixing of the gases can be reduced to a few tanks.

If there is more natural gas than CO₂ on a volume basis, transport can be carried out at a higher pressure for natural gas. On the other hand if there is more CO₂ than natural gas on a volume basis, transport can be carried out at a higher pressure for CO₂ than for natural gas.

With supply of natural gas fuel to a thermal power plant and return of 90%, or more, of produced CO₂, there typically will be more natural gas on a volume basis. It will be possible to carry out transport at 200 to 250 barg for natural gas at a temperature from 10-25° C. Depending on the composition of the natural gas, return transport of CO₂ will be at 100 to 150 barg at a temperature from 35-60° C.

Typical pressure and temperature in the present storage device will, for natural gas, be 200 barg at 10° C. and for CO₂ will be 120 barg and 38° C. If one should use the same pressure for both gases, the temperature of the natural gas ought to be 45-50° C. colder than the temperature of CO₂ so that one can transport the same amount of gas both ways. At the same temperature of the gases, the pressure of the natural gas must be about 150 bar higher than the pressure of CO₂ to transport the same amount of gas both ways. If the amount of gas is larger one way than the other way, pressure and temperature can be adjusted accordingly.

Typically, the tanks will work above the cricondenbar for the gas mixtures that might occur, i.e. in an area where liquid does not occur (the same is normal at transport in pipelines). The cricondenbar varies with the gas composition, but lies typically from somewhat below to somewhat above 100 barg.

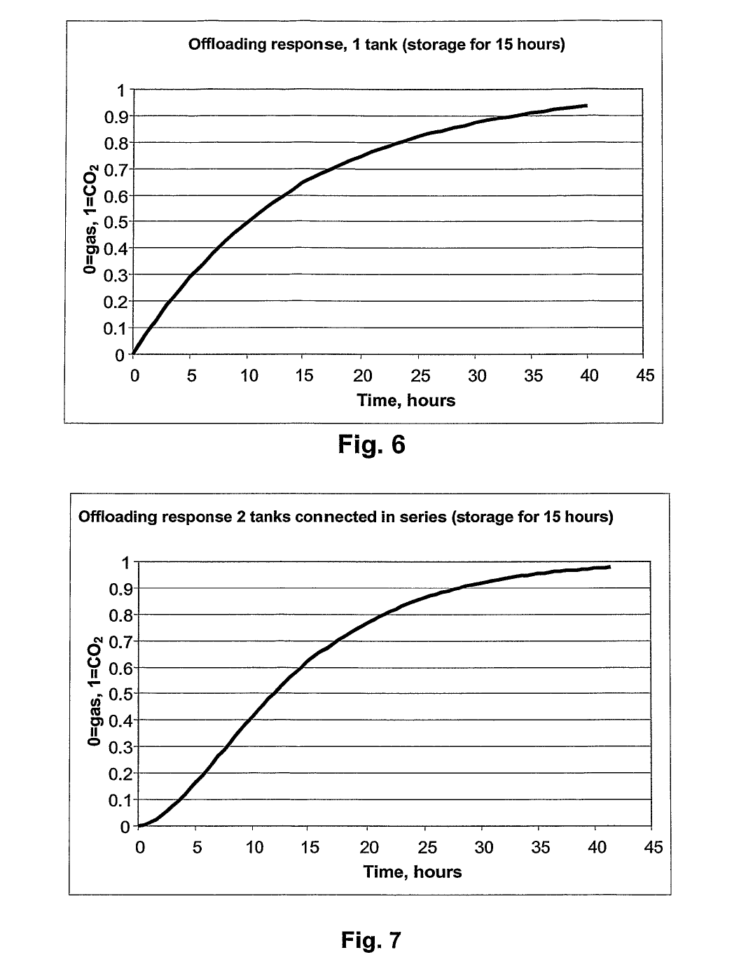

FIG. 6 shows the composition of the gas that is taken out of a storage tank, as a function of time. The tank is initially filled with natural gas and where the tank is emptied for natural gas from the top at the same time as the natural gas is replaced by CO₂ which is filled from the bottom of the tank. The calculations on which the curve is based assume that the gases, i.e. CO₂ and natural gas, are completely mixed in the tank. Total residence time in the tank (i.e. the relationship between volume in m³ and through-flow in m³/h) is 15 hours. If there was plug flow in the tank, i.e. that the incoming gas pushes the gas that is taken out in front of it, or if there had been a piston as described in NO 2003 4499 to separate the phases, it would have taken 15 hours to take out all the natural gas. In this calculation model, it will take 33 hours to unload 90% of the natural gas by supplying CO₂ At the same time, one will get a natural gas which is much contaminated by CO₂.

FIG. 7 shows the composition of the gas which is taken out of a storage system with two tanks connected in series, as a function of time, where the tanks are initially filled with natural gas and where the tanks are emptied at the same time as the natural gas is replaced by CO₂. This calculation model also assumes that the incoming gas in each tank is mixed completely with the content of the tank and that the total volume in the two tanks is equal to the volume in the one tank in FIG. 6. Total residence time in the tank (i.e. the relationship between volume in m³ and through-flow in m³/h) is 15 hours. By using two tanks, 90% of the natural gas will be unloaded in about 28 hours according to this model, i.e. five hours are saved in the unloading compared to using one tank only. In addition, the mixing in of CO₂ in the unloaded natural gas will be significantly less than when using one tank only.

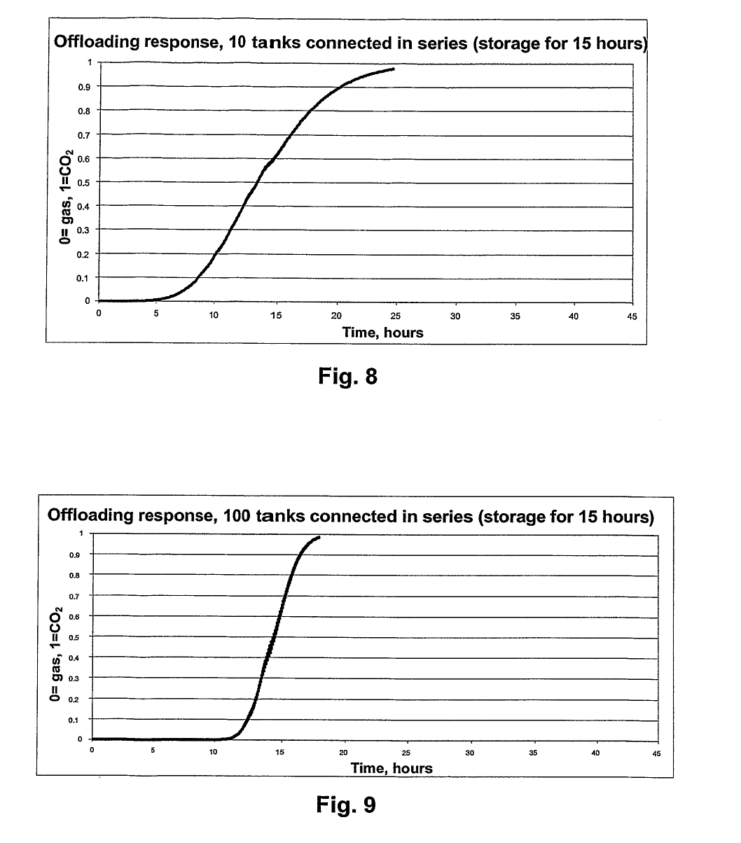

FIG. 8 shows the composition of the gas that is taken out of a storage system with ten tanks connected in series, as a function of time, where the tanks are initially filled with natural gas and where the tanks are emptied at the same time as the natural gas is replaced by CO₂. This calculation model also assumes that the incoming gas in each tank is mixed completely with the content of the tank and also that the total volume of the ten tanks is equal to the volume of the one tank in FIG. 6. Total residence time in the tank (i.e. the ratio between volume in m³ and through-flow in m³/h) is 15 hours. By using ten tanks, 90% of the natural gas will be unloaded in about 18 hours according to this model, i.e. 15 hours are saved in the unloading compared to using one tank only. In addition, the mixing in of CO₂ in the unloaded natural gas will be significantly reduced.

FIG. 9 shows the composition of the gas that is taken out of a storage system with one hundred tanks connected in series, as a function of time, where the tanks are initially filled with natural gas and where the tanks are emptied at the same time as the natural gas is replaced by CO₂. This calculation model also assumes that the incoming gas in each tank is completely mixed with the content of the tank and also that the total volume in the hundred tanks is equal to the volume in the one tank in FIG. 6. Total residence time in the tank (i.e. the relationship between volume in m³ and through-flow in m³/h) is 15 hours. By using one hundred tanks, 90% of the natural gas will be unloaded in about 16 hours according to this model. The unloaded gas will be pure natural gas for the first 12 hours. After 12 hours, the content of CO₂ in the unloaded gas will increase, but the total amount of CO₂ in the total unloaded natural gas will be relatively small compared to using one tank only.

The FIGS. 6 to 9 illustrate that the performance of such a system, i.e. the approach to ideal plug flow, improves with the number of tanks connected in series.

The calculations on which the FIGS. 6 to 9 are based assume that the tanks are ideally mixed vessels, where the gases in the tank are completely mixed at any time. However, CO₂ has a tendency to go to the bottom of the tank during filling and emptying while natural gas will lie at the top of a tank where both gases are present. Mixing of the gases will be slow and determined by the flow pattern in the tank and diffusion phenomena. This slow mixing of the gases, together with the gas containing most CO₂ being loaded and emptied from the tanks through an opening near, or in the bottom of the tank, will result in the flow of gas through the tank being nearer plug flow than what appears to be the case in the FIGS. 6 to 9. To reduce even further the mixing of the gases in tanks where both gases are present, the openings of the CO₂ pipe, natural gas pipe and also connecting pipes can be formed so that vortexing in the tanks is reduced as much as possible during emptying and filling. This is illustrated in FIG. 3 with an enlargement of the outlet of the connection pipe in the bottom of tank 1. Other efforts, such as a rounding 24 of the bottom of the tank, see FIG. 3, and application of physical barriers as shown by the grid 22 in FIG. 3, will also be able to reduce vortex formation and thus mixing of the gases in the tank.

Even if the FIGS. 6-9 show that approaching the desired plug flow, i.e. with minimal mixing of the gases, improves the more tanks one uses in series, practical and safety considerations place restrictions on the maximum number of tanks. To maintain a reasonable flow velocity, and thus reasonable unloading speed and loading speed, the dimensions of the connection pipes must be increased with increasing numbers of tanks. This increases the danger of breakages and leakage of large amounts of gas at such breakages. Preliminary calculations show that at least 5 tanks are required to get a satisfactory separation of the gases. Furthermore, based on the abovementioned reasons, it is assumed that it is not appropriate to have an installation of more than 200 tanks in series. It is assumed from the present calculations that an installation of the present type will have from 10 to 100 tanks, 20 to 50 tanks, or from 30 to 40 tanks, in all cases connected in series.

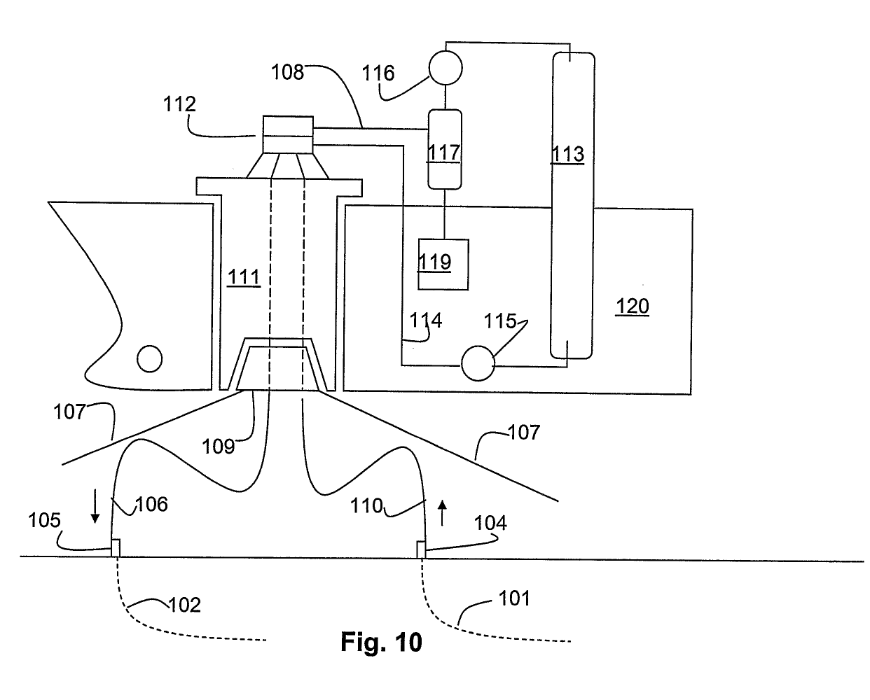

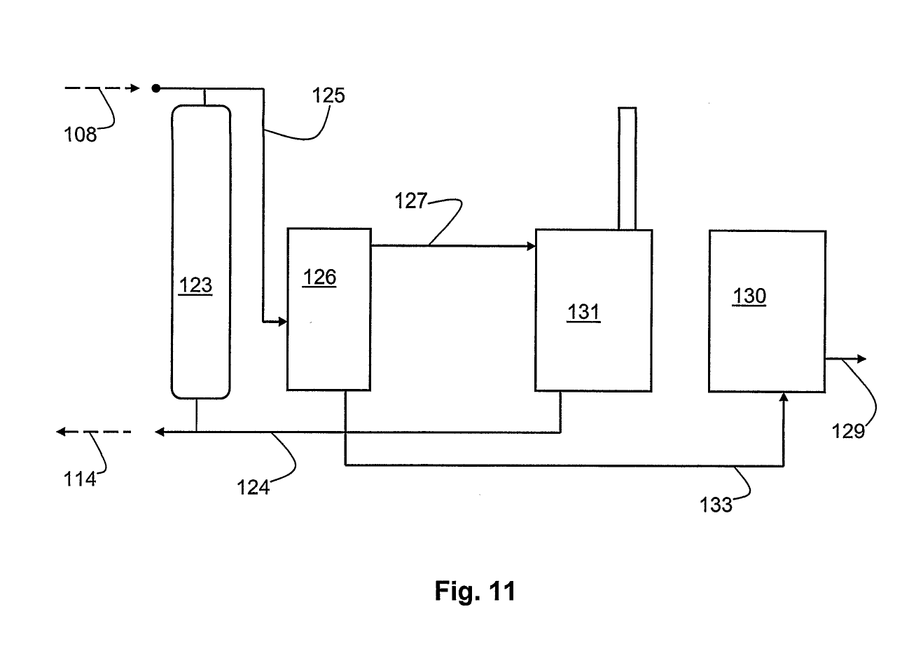

FIG. 10 shows a ship with the present tank installation onboard and which is connected to a loading buoy during loading of natural gas and unloading of CO₂ for re-injection. FIG. 11 shows a land-based installation comprising a thermal power plant.

With reference to FIG. 10, the well stream is taken up through a production well 101 and CO₂ is injected through an injection well 102. Flexible production pipes 110 and injection pipes 106 run from the wellheads 104, 105 on the bottom 103 to an anchorage buoy 109. The anchorage buoy 109 is fastened to the bottom 103 with anchorage lines 107. The anchorage buoy 109 is a traditional buoy for this use which is temporarily secured to the vessel 120 in a turret 111.

The flexible pipes 106, 110 run up from the anchorage buoy and up to a swivel 112 on the deck of the ship. From the swivel 112, the incoming natural gas is led in a pipe 110 that comes from the gas well 101, in a natural gas pipe 108 to a storage unit 113. The storage unit 113 is a storage unit as described above, comprising a series of tanks connected in series, but is represented by one tank in the figure for simplicity. It can be appropriate that a sand trap 117, with associated sand storage facility 119, is arranged between the swivel 119 and the storage unit 113 for removal of sand that follows the incoming gas. Furthermore, a pump 116 must be arranged between the gas well 101 and the storage unit 113 to pump the well stream into the storage unit.

Natural gas is supplied as described above with reference to FIG. 1 near the top of a tank at the one end of the tanks that are connected in series, while CO₂ is taken out near the bottom of a tank at the opposite end of the series of tanks.

CO₂ is taken out from the storage installation 113 in a CO₂ line 114 and is pumped further down into the injection well with the help of a pump 115.

After loading of the well stream and emptying of CO₂, the vessel goes to an installation ashore. FIG. 11 shows schematically an example of such an installation. Here, the natural gas pipe 108 from the vessel is connected to a well stream pipe 125 for transfer of natural gas from the storage installation 113 of the vessel to the land-based installation. The transferred natural gas can be temporarily stored in a storage installation, for example, of the present type, here exemplified with a tank 123. The CO₂ pipe 114 from the vessel is connected together with the CO₂ pipe 124 of the land-based installation for transfer of CO₂ from the land-based installation and onboard the storage installation 113.

The natural gas can be led directly to a pre-treatment unit 126 and to the storage unit 123. The natural gas, whether it comes directly from the ship or has been temporarily stored in the storage unit 123, will normally contain a certain fraction of condensable components. These components are condensed in the pre-treatment unit 126. From the pre-treatment unit, the condensate is led, via a pipe 133, to a storage unit 130. The condensate can be exported from the installation from the storage unit 130.

The remaining gas from the pre-treatment unit 126 is led to a gas-driven power plant 131 via a fuel pipe 127.

The gas-driven power plant comprises a separation unit for CO₂, and separated CO₂ is led, via a CO₂ pipe 124, to the storage unit 123 or can be sent directly onboard the vessel if this is connected to the installation.

The land-based installation shown is only an example and other types of land-based installations, where CO₂ is generated from natural gas, of course can be used.

The present invention makes utilisation of smaller oilfields and gas fields possible. These fields are not developed today as it is too costly to build processing installations on the fields, or to build pipelines. The processing of the gas and use of this can be placed ashore and one can utilise such fields without placing processing equipment on the field or laying pipelines. In the present description it must be understood that a gas-driven power plant and other processing installations, respectively, must not necessarily lie ashore, but can also lie on an installation at sea.

1. A method for alternating storage of natural gas and CO₂ in a tank installation, where the gases are stored in a plurality of tanks that are connected in series where natural gas is supplied to and taken out of, respectively, one tank at one end of the tanks that are connected in series and where CO₂ is supplied to and taken out of, respectively, a tank at the opposite end of the tanks that are connected in series.

2. Method according to claim 1, where the natural gas and CO₂ have a pressure and a temperature that lie above the cricondenbar of the actual gas.

3. Method according to claim 2, where natural gas is stored at a pressure of from 120 to 300 barg, and CO₂ is stored at a pressure of from 80 to 150 barg.

4. Method according to claim 1, where the tank installation is arranged onboard a vessel and where natural gas is supplied to the tank installation and where CO₂ is emptied from the tank installation when the vessel lies connected to a gas field and is emptied of natural gas, and is supplied CO₂ when the vessel lies at an installation for use of the natural gas.

5. A combined installation for alternating storage of natural gas and CO₂, where the installation comprises a plurality of tanks (1, 1′, . . . 1^{n′}) that are connected in series with the help of connection pipes (4,4′, . . . 4^{n′}) and where a CO₂ line (2), which is connected to a first tank (1) in the series of tanks, is arranged for supply of CO₂ and removal of CO₂, respectively, from the tank installation, and a natural gas line (3) is arranged for removal of natural gas and supply of natural gas, respectively, to a last tank (1^{n′}) in the series of tanks.

6. Combined storage facility according to claim 5, where the CO₂ line (2) has an outlet near the bottom of the first tank (1) and that the natural gas line (3) has an outlet near the top of the last tank (1^{n′}).

7. Combined storage facility according to claim 5, where the connection pipes (4, 4′, . . . 4^{n′}) have a first opening near the top of the tank which, streamwise, lies nearest the first tank (1) and a second opening near the bottom of the next tank in the series of tanks.

8. Combined storage facility according to claim 5, where the installation comprises from 5 to 200 tanks in series.

9. Combined storage facility according to claim 8, where the installation comprises from 20 to 50 tanks in series.

10. Vessel for alternating transport of natural gas and CO₂, where the vessel comprises a tank installation encompassing a plurality of tanks (1, 1′, . . . 1^{n′}) which are connected in series with the help of connection pipes (4, 4′, . . . 4^{n′}) and where a CO₂ line, which is connected to a first tank (1) in the series of tanks (2), is arranged for supply of CO₂ to and removal of CO₂ from, respectively, the tank installation, and a natural gas line (3) is arranged for removal of natural gas and supply of natural gas, respectively, to a last tank (1^{n′}) in the series of tanks.

11. Combined storage facility according to claim 6, where the connection pipes (4, 4′, . . . 4^{n′}) have a first opening near the top of the tank which, streamwise, lies nearest the first tank (1) and a second opening near the bottom of the next tank in the series of tanks.

12. Combined storage facility according to claim 6, where the installation comprises from 5 to 200 tanks in series.

13. Combined storage facility according to claim 7, where the installation comprises from 5 to 200 tanks in series.
